(19) United States
(12) Patent Application Publication
(10) Pub. No.: US 2024/0060839 A1
(43) Pub. Date: Feb. 22, 2024

(54) SENSORS AND SENSOR SYSTEMS FOR MEASURING SHEAR FORCE AND VERTICAL TORQUE

(71) Applicant: Orpyx Medical Technologies Inc., Calgary (CA)

(72) Inventor: SAMUEL CARL WILLIAM BLADES, VICTORIA (CA)

(21) Appl. No.: 18/447,588

(22) Filed: Aug. 10, 2023

Related U.S. Application Data
(60) Provisional application No. 63/399,295, filed on Aug. 19, 2022.

(51) Int. Cl. G01L 5/00; G01L 5/16

(52) U.S. Cl. CPC G01L 5/0076; G01L 5/16

(57) ABSTRACT

A force sensor and sensor system for measuring shear force and/or vertical torque. The force sensor has an upper substrate layer, a lower substrate layer, an upper sensor portion, and a lower sensor portion. The upper sensor portion has an upper conductive layer and an upper force-sensitive resistor layer applied to the upper conductive layer. The lower sensor portion has a lower conductive layer applied to the upper surface of the lower substrate layer and a lower force-sensitive resistor layer applied to the lower conductive layer. The lower force-sensitive resistor layer and the upper force-sensitive resistor layer are laterally offset under a zero-shear force condition and/or a zero-torque condition and the lower force-sensitive resistor layer and the upper force-sensitive resistor layer are moveable laterally towards or away from each other in response to a shear force and/or a torque.

### CROSS-REFERENCE TO RELATED APPLICATIONS

This application claims the benefit of priority of U.S. Provisional Application No. 63/399,295 filed Aug. 19, 2022, which is incorporated herein by reference.

### FIELD

This document relates to force sensors for monitoring human movement or human activity. In particular, this document relates to sensors for measuring shear force and vertical torque.

### BACKGROUND

U.S. Pat. No. 10,310,695 (Perlin et al.) discloses a sensor having a set of plates that are in contact from their bottom at the corners with a set of protrusions that are in contact from above with a plurality of intersections, each having a sensing element of a grid of wires disposed on a base, and a top surface layer that is disposed atop the set of plates. The force imparted from above onto the top surface layer is transmitted to the plates and then to the protrusions, and then to the intersections of the grid of wires which are thereby compressed between the base and protrusions. The protrusions above thereby focus the imparted force directly onto the intersections. The sensor includes a computer in communication with the grid which causes prompting signals to be sent to the grid and reconstructs a continuous position of force on the surface from interpolation based on data signals received from the grid. Further disclosed is a method for sensing.

United States Patent Application Publication No. 2021/0285835 (Perlin et al.) discloses a sensor having a layer and one or more sensing elements which sense shear force and compressive force on the layer. The sensor has a computer in communication with the one or more sensing elements which causes prompting signals to be sent to the one or more sensing elements and reconstructs shear force and compressive force on the layer from data signals received from the one or more sensing elements. Further disclosed are methods for sensing forces and for producing a sensor.

### SUMMARY

The following summary is intended to introduce the reader to various aspects of the detailed description, but not to define or delimit any invention.

Sensors and sensor systems for measuring shear force and vertical torque are provided. In general, such sensors may include sensor layers that are arranged to sense shear forces and/or torques. Such sensors can include laterally offset layers that are moveable in response to a shear force and/or a torque. The offset layers can include force-sensing resistor layers that vary the resistance of a circuit through a sensor unit in response to movement towards or away from one another. The force sensors can allow shear force and/or torque to be measured directly and in real-time while a user is in the field.

According to some aspects, a force sensor includes: an upper substrate layer having a lower surface; an upper sensor portion including: an upper conductive layer applied to the lower surface of the upper substrate layer; and an upper force-sensitive resistor layer applied to the upper conductive layer; a lower substrate layer having an upper surface in a facing relationship with the lower surface of the upper substrate layer; a lower sensor portion including: a lower conductive layer applied to the upper surface of the lower substrate layer; and a lower force-sensitive resistor layer applied to the lower conductive layer; wherein the lower force-sensitive resistor layer and the upper force-sensitive resistor layer are laterally offset under a zero-shear force condition and/or a zero-torque condition; and the lower force-sensitive resistor layer and the upper force-sensitive resistor layer are moveable laterally towards or away from each other in response to a shear force and/or a torque.

The lower force-sensitive resistor layer and the upper force-sensitive resistor layer can be in contact under the zero-shear force condition and/or the zero-torque condition.

The lower force-sensitive resistor layer and the upper force-sensitive resistor layer can be spaced apart under the zero-shear force condition and/or the zero-torque condition.

Each of the upper sensor portion and the lower sensor portion can have a symmetrical profile.

Each of the upper sensor portion and the lower sensor portion can have a rectangular profile.

Each of the upper sensor portion and the lower sensor portion can have a non-rectangular profile.

The non-rectangular profile can be a triangular profile.

The non-rectangular profile can be a trapezoidal profile.

The upper force-sensitive resistor layer can include a plurality of upper force-sensitive strips applied to the upper conductive layer; and the lower force-sensitive resistor layer can include a plurality of lower force-sensitive strips applied to the lower conductive layer.

The plurality of upper force-sensitive strips can be parallel and the plurality of lower force-sensitive strips can be parallel.

The plurality of upper force-sensitive strips can be arranged in an upper pinwheel pattern and the plurality of lower force-sensitive strips can be arranged in a lower pinwheel pattern.

The plurality of upper force-sensitive strips and the plurality of lower force-sensitive strips can be evenly spaced from one another under the zero-shear condition.

The plurality of upper force-sensitive strips and the plurality of lower force-sensitive strips can be unevenly spaced from one another under the zero-shear condition.

Each of the upper sensor portion and the lower sensor portion can have a right-angle triangle profile.

The upper force-sensitive resistor layer can be applied to one or more upper lateral sides of the upper conductive layer and the lower force-sensitive resistor layer can be applied to one or more lower lateral sides of the lower conductive layer.

The force sensor can be manufactured using additive manufacturing.

Each conductive layer can include conductive ink.

Each force-sensitive resistor layer can include force-sensitive resistor (FSR) ink.

The upper conductive layer can include one or more interacting lateral surface portions and one or more non-interacting lower surface portions and the lower conductive layer can include one or more interacting lateral surface portions and one or more non-interacting upper surface portions. Each interacting lower surface portion can be positioned to contact a corresponding interacting upper surface portion under certain applied force conditions. The upper force-sensitive resistor layer can be omitted from the non-interacting lower surface portions and the lower force-sensitive resistor layer can be omitted from the non-interacting upper surface portions.

According to some aspects, a sensor system includes: a plurality of force sensors arranged in a predetermined pattern, the plurality of force sensors including at least one normal force sensor and at least one additional type of force sensor, wherein the at least one additional type of force sensor includes at least one of a medial-lateral shear force sensor, an anterior-posterior shear force sensor, or a vertical torque sensor; and one or more processors communicatively coupled to the plurality of force sensors, the one or more processors configured to transmit signals external to the sensor system based on an output of the plurality of force sensors.

The at least one additional type of force sensor can include one or more force sensors such as the force sensors defined herein.

The plurality of force sensors can include a plurality of force sensor layers.

Each force sensor layer can include a different type of force sensor.

At least one force sensor layer can include a plurality of different types of force sensors.

At least some of the force sensors from different force sensor layers can at least partially overlap one another.

The sensor system can include a wearable device including the plurality of force sensors and the one or more processors.

The wearable device can be worn on a foot.

The wearable device can be an insole for footwear.

The insole can include a first layer, a base layer, and the plurality of force sensors and the one or more processors can be disposed between the first layer and the base layer.

The sensor system can include an inertial measurement unit.

The at least one additional type of force sensor can include at least one of the medial-lateral shear force sensor or the anterior-posterior shear force sensor, and the one or more processors can be further configured to adjust the sensor readings obtained from the at least one of the medial-lateral shear force sensor or the anterior-posterior shear force sensor based on sensor readings from the at least one normal force sensor.

According to some aspects, a method of manufacturing a force sensor includes printing conductive ink onto a lower surface of an upper substrate to form an upper conductive layer; printing FSR ink onto the lower or lateral surface of the upper conductive layer to form an upper force-sensitive resistor layer; printing conductive ink onto an upper surface of a lower substrate to form a lower conductive layer; printing FSR ink onto the upper or lateral surface of the lower conductive layer to form a lower force-sensitive resistor layer; and arranging the lower force-sensitive resistor layer and the upper force-sensitive resistor layer to be in a laterally offset position under a zero-shear force condition and/or a zero-torque condition and to be moveable laterally towards or away from each other in response to a shear force and/or a torque.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram illustrating an example of a force sensor system;

FIG. 2A is a diagram illustrating an example of a wearable device incorporating a sensing unit that can be used in the system of FIG. 1;

FIG. 2B is a diagram illustrating an example of a sensing unit that can be used with the wearable device of FIG. 2A;

FIG. 3 is a diagram illustrating forces acting on an example wearable device in the form of an insole.

FIG. 4A is a diagram of an example sensor for measuring a normal force.

FIG. 4B is a diagram of an example sensor for measuring shear force and/or torque.

FIGS. 5A-5D are diagrams of example sensors with various cross-sectional profiles.

FIGS. 6A-6C are diagrams of an example sensor with an interdigitated profile.

FIGS. 7A-7C are diagrams of an example sensor with an interdigitated profile.

FIGS. 8A-8C are cross-sectional diagrams of an example sensor in various loading positions.

FIGS. 8D-8F are top view diagrams of the sensor of FIGS. 8A-8C respectively.

FIG. 8G is a plot of resistance vs. force showing the loading positions corresponding to the sensors shown in FIGS. 8A-8F.

FIGS. 9A-9C are cross-sectional diagrams of an example sensor in various loading positions.

FIGS. 9D-9F are cross-sectional diagrams of an example sensor in various loading positions.

FIG. 9G is a plot of resistance vs. force showing the loading positions corresponding to the sensors shown in FIGS. 9A-9F.

FIGS. 10A-10C are diagrams of an example sensor with an interdigitated profile.

FIG. 11A is a diagram of an example sensor with an interdigitated profile in a zero-torque condition.

FIG. 11B is a diagram of an example sensor with an interdigitated profile in a clockwise torque condition.

FIG. 11C is a diagram of an example sensor with an interdigitated profile in a counter-clockwise torque condition.

FIG. 11D is a plot of resistance vs. torque showing the loading positions corresponding to the sensors shown in FIGS. 11A-11C.

FIG. 12A is a diagram of an example sensor with an interdigitated profile in a zero-torque condition.

FIG. 12B is a diagram of an example sensor with an interdigitated profile in a clockwise torque condition.

FIG. 12C is a diagram of an example sensor with an interdigitated profile in a counter-clockwise torque condition.

FIG. 12D is a plot of resistance vs. torque showing the loading positions corresponding to the sensors shown in FIGS. 12A-12C.

FIG. 13A is a diagram of an example sensor set positioned in a wearable device.

FIG. 13B is an exploded diagram of an example sensor set positioned in a plurality of layers of a wearable device.

FIG. 13C is a collapsed diagram of the wearable device of FIG. 13B.

FIG. 14A is a top view of an example sensor.

FIG. 14B is a cross-sectional diagram of the sensor of FIG. 14A.

FIG. 15 is a flow chart illustrating an example method of manufacturing a sensor.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

The terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal, or a mechanical element depending on the particular context. Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof. Furthermore, the wording “at least one of A and B” is intended to mean only A (i.e., one or multiple of A), only B (i.e., one or multiple of B), or a combination of one or more of A and one or more of B.

Terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Described herein are sensors and sensor systems for measuring shear force and vertical torque. Also described herein are methods of manufacturing and using force sensors for measuring shear force and vertical torque. The force sensors can include opposing sensor layers that are laterally offset and moveable relative to one another in response to a shear force and/or torque. The force sensors may be provided with force sensing layers arranged to provide interdigitated patterns of sensor layers in response to the shear force and/or torque. The systems, methods, and devices can use sensors attached to, or contained within, wearable devices, fitness equipment or fitness accessories to measure and monitor data relating to movement or activity of an individual.

The sensors can be force sensors and can be provided in an insole for footwear or within the footwear worn by the individual. As used herein, the term “force” is used broadly and can refer to raw force (i.e., with units of N), or pressure resulting from a raw force (i.e., with units of N/m 2). The force data acquired by the force sensors can be used to, for example, determine the level of force applied by an individual's foot when walking, running, or jumping (or doing any other activity). This force data can be used to derive additional force derivatives or force-based metrics, such as the force output or the center of pressure for the individual. The force data, and other data derived therefrom, can be used for tracking and monitoring various parameters that may be useful for medical, fitness, athletic, security, gaming, entertainment or other purposes.

The systems, methods, and devices described herein may be implemented as a combination of hardware or software. In some cases, the systems, methods, and devices described herein may be implemented, at least in part, by using one or more computer programs, executing on one or more programmable devices including at least one processing element, and a data storage element (including volatile and non-volatile memory and/or storage elements). These devices may also have at least one input device (e.g., a pushbutton keyboard, mouse, a touchscreen, and the like), and at least one output device (e.g., a display screen, a printer, a wireless radio, and the like) depending on the nature of the device.

Some elements that are used to implement at least part of the systems, methods, and devices described herein may be implemented via software that is written in a high-level procedural language such as object-oriented programming. Accordingly, the program code may be written in any suitable programming language such as Python or C for example. Alternatively, or in addition thereto, some of these elements implemented via software may be written in assembly language, machine language, or firmware as needed. In either case, the language may be a compiled or interpreted language.

At least some of these software programs may be stored on a storage media (e.g., a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

The present disclosure relates to force sensors and sensor systems that can be used to measure shear forces and/or torques. Each force sensor can include two force sensing portions that are laterally offset when the sensors are not experiencing shear force and are not experiencing torques. The force sensing portions can move towards or away from one another in response to a shear force and/or a torque. The force sensors can generate sensor readings representative of the shear force and/or torque in response to the relative positioning of the sensor portions.

A sensor system is also provided that includes a plurality of normal force sensors as well as additional force sensors usable to measure shear forces and/or torques. The sensor system can be integrated into a wearable device such as an insole or other footwear for example. The sensor system can thus directly measure shear forces and/or torques acting on the wearable device. This can provide useful force and torque data that can be used to evaluate athletic performance and/or predict a user's risk of injury.

A method of manufacturing force sensors is also provided. Conductive ink can be printed onto an upper and lower substrate respectively to form separate conductive layers. Force-sensing resistive ink can then be printed onto the respective conductive layers to form an upper and lower FSR layer. The upper and lower FSR layers can be arranged to be laterally moveable (towards and/or away from one another) in response to shear force and/or torque.

In the discussion that follows, the arrangement of sensor components is described using terms such as upper and lower, vertical and lateral, and so forth. Such terms are used for simplicity and should not be interpreted as requiring that a particular feature be above or below another feature. Rather, such terms are used to describe a relative arrangement of elements and not to specify a particular orientation of a sensor or elements of the sensor. Elements referenced using the terms “upper” and “lower” may have different relative orientations depending on the implementation of a sensor or sensor system, or the circumstances in which such sensor or sensor system is being used.

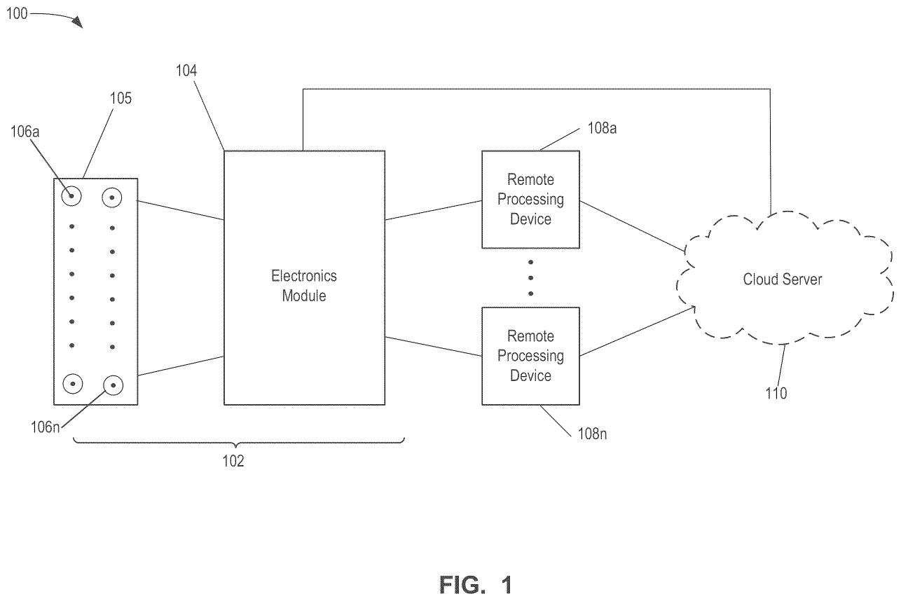

Referring now to FIG. 1, shown therein is a block diagram illustrating an example sensor system 100. System 100 can be used to obtain and monitor force sensor data for a user. The force sensor data can be used to monitor aspects of human movement and/or activity.

System 100 includes an input unit 102 (also referred to herein as an input device), one or more processing devices 108 (also referred to herein as a receiving device or an output device) and optionally a remote cloud server 110. As will be described in further detail below, the input unit 102 may for example be combined with, or integrated into, a carrier unit such as a wearable device, a piece of fitness equipment or a fitness accessory.

Input unit 102 generally includes a sensing unit 105. The sensing unit 105 can include a plurality of sensors 106a-106n. The plurality of sensors 106a-106n can be arranged in a first predetermined pattern that maps each sensor 106 to a corresponding location of the carrier unit.

The carrier unit can be configured to hold the sensors 106 in contact with (or in close proximity to) an individual's body to allow the sensors 106 to measure an aspect of the activity being performed by the individual. The plurality of sensors 106a-106n may be configured to measure a particular sensed variable at a location of an individual's body when the carrier unit is engaged with the individual's body (e.g., when the individual is wearing a wearable device containing the sensors 106 or when the individual is using fitness equipment containing the sensors 106).

In some examples, the carrier unit may include one or more wearable devices. The wearable devices can be manufactured of various materials such as fabric, cloth, polymer, or foam materials suitable for being worn close to, or in contact with, a user's skin. All or a portion of the wearable device may be made of breathable materials to increase comfort while a user is performing an activity.

In some examples, the wearable device may be formed into a garment or form of apparel such as a band, headwear, a shirt, shorts, a sock, a shoe, a sleeve, and a glove (e.g., a tactile glove). Some wearable devices such as socks or sleeves may be in direct contact with a user's skin. Some wearable devices, such as shoes or backpacks, may not be in direct contact with a user's skin but may still be positioned within sufficient proximity to a user's body to allow the sensors to acquire the desired readings.

In some cases, the wearable device may be a compression-fit garment. The compression-fit garment may be manufactured from a material that is compressive. A compression-fit garment may minimize the impact from “motion artifacts” by reducing the relative movement of the wearable device with respect to a target location on the individual's body. In some cases, the wearable device may also include anti-slip components on the skin-facing surface. For example, a silicone grip may be provided on the skin-facing surface of the wearable device to further reduce the potential for motion artifacts.

In some examples, the wearable device may be worn on a foot. For example, the wearable device may be a shoe, a sock, or an insole, or a portion of a shoe, a sock, or an insole. The wearable device may include a deformable material, such as foam. This may be particularly useful where the wearable device is worn underfoot, as in a shoe or insole.

The plurality of sensors 106a-106n can be positioned to acquire sensor reading from specified locations on an individual's body (via the arrangement of the sensors on the carrier unit). The sensors 106 can be integrated into the material of the carrier unit (e.g., integrated into a wearable device, fitness equipment or fitness accessory). Alternatively, the sensors 106 can be affixed or attached to the carrier unit, e.g., printed, glued, laminated or ironed onto a surface, or between layers, of a wearable device, fitness equipment or fitness accessory.

In some examples, the carrier unit may include fitness equipment or other fitness accessories. The fitness equipment may include various types of fitness equipment on which a user can exert force while performing an activity. For example, the carrier unit may be fitness equipment such as an exercise mat, a fitness bench, a bar (e.g., a squat rack or a pull-up bar), a treadmill, or a bicycle seat for a bicycle or stationary bicycle. The fitness accessories may include various types of fitness accessories on which a user can exert force while performing an activity, such as tactile gloves or a backpack for example.

For clarity, the below description relates to a carrier unit in the form of an insole. The insole carrier unit may be provided in various forms, such as an insert for footwear or integrated into a shoe. However, other carrier units may be implemented using the systems and methods described herein, such as the example wearable devices, fitness equipment, and fitness accessories described above.

Various types of force sensors may be used, such as force sensing resistors (also referred to as “sensels” or sensing elements), pressure sensors, piezoelectric tactile sensors, elasto-resistive sensors, capacitive sensors or more generally any type of force sensor that can be integrated into a wearable device or fitness equipment.

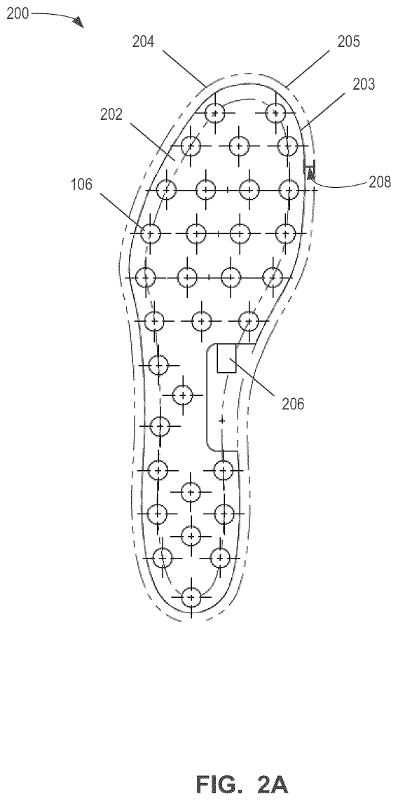

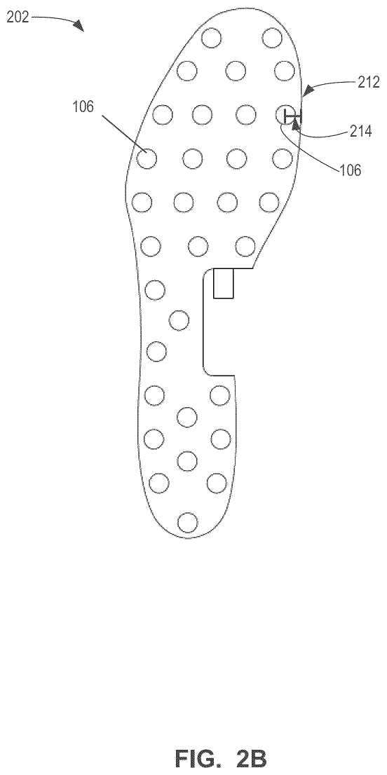

The plurality of sensors 106 can include normal force sensors provided as a set of discrete sensors (see e.g., FIG. 2B). A discrete sensor is an individual sensor that acquires a sensor reading at a single location. A set of discrete sensors generally refers to multiple discrete sensors that are arranged in a spaced apart relationship in a sensing unit. The spaced apart relationship can define void locations where no sensors are located.

The sensors 106a-106n may be arranged in a sparse sensor array that includes void locations where no sensors 106 are located. A sensor array (as used herein) refers to a series of sensors arranged in a predefined layout. In a continuous or dense sensor array, in contrast to a set of discrete sensors that may provide a sparse sensor array, the sensors within the dense sensor array are arranged in a continuous, or substantially continuous manner, across the predefined layout. That is, a dense sensor array is considered to be capable of acquiring actual sensor readings at all locations of the sensor array. Thus, the dense sensor array does not typically need to estimate sensor values at interstitial locations or locations external to the array. The dense sensor array provides a comprehensive understanding of sensed values throughout the locations engaged by the corresponding layout.

Discrete sensors can provide an inexpensive alternative to dense sensor arrays for many applications. However, because no sensors are positioned in the interstitial locations between the discrete sensors, no actual sensor readings can be acquired for the interstitial locations. Similarly, because no sensors are positioned in the void locations external to the set of discrete sensors, no actual sensor readings can be acquired for the external void locations. In order to provide sensor data with similar resolution to a dense sensor array, sensor readings must be estimated (rather than measured) at the interstitial locations and at the void locations external to the set of discrete sensors.

Various interpolation and extrapolation techniques may be used to estimate sensor values at interstitial locations and external void locations. In some cases, sensor values may be estimated using the methods for synthesizing sensor data described in Applicant's co-pending patent application Ser. No. 17/988,468 filed on Nov. 16, 2022 entitled “SYSTEM AND METHOD FOR SYNTHESIZING SENSOR READINGS”, the entirety of which is incorporated herein by reference. In some cases, sensor values may be estimated using the methods for synthesizing sensor data described in Applicant's co-pending patent application Ser. No. 18/183,642 filed on Mar. 14, 2023 entitled “SYSTEM AND METHOD FOR DETERMINING USER-SPECIFIC ESTIMATION WEIGHTS FOR SYNTHESIZING SENSOR READINGS”, the entirety of which is incorporated herein by reference.

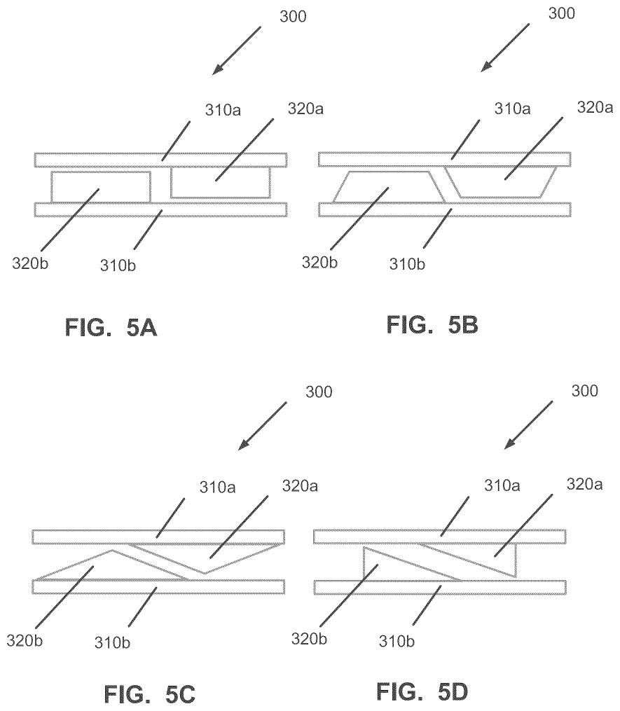

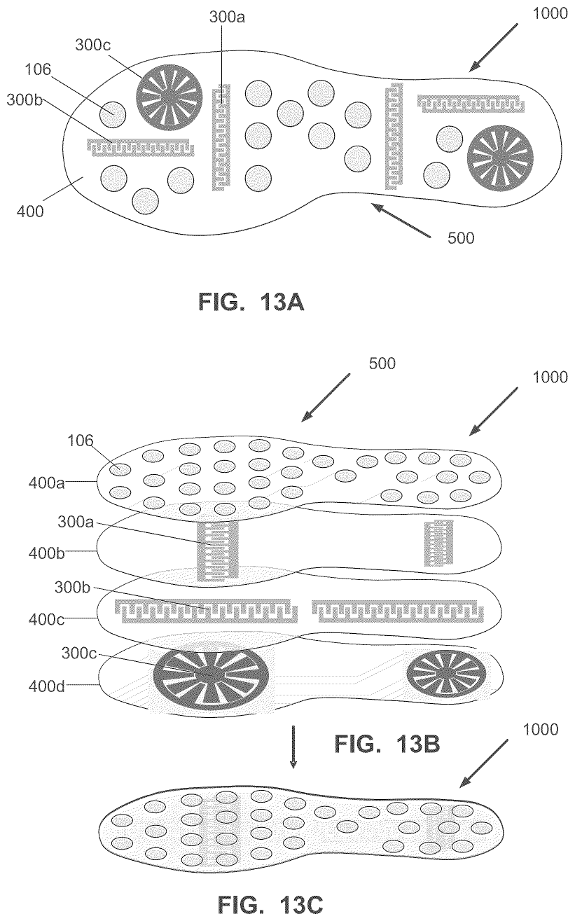

The plurality of sensors can also include at least one additional type of sensor (i.e., in addition to force sensors configured to measure normal forces). For example, the additional type of sensor(s) can include one or more of a medial-lateral shear force sensor, an anterior-posterior shear force sensor, or a vertical torque sensor. The at least one additional type of sensor may be provided using a force sensor with laterally offset sensing layers, such as the example sensors shown in FIGS. 5-12 and described in further detail herein below. An example sensor system incorporating a plurality of normal force sensors and at least one additional type of sensor is shown in FIGS. 13A-13C and described in further detail herein below.

As shown in FIG. 1, input unit 102 includes an electronics module 104 coupled to the plurality of sensors 106. In some cases, the electronics module 104 can include a power supply, a processor, a memory, a signal acquisition unit operatively coupled to the processor and to the plurality of sensors 106, and a wireless communication module operatively coupled to the processor.

Generally, the sensing unit refers to the plurality of sensors 106 and the signal acquisition unit. The signal acquisition unit may provide initial analog processing of signals acquired using the sensors 106, such as amplification. The signal acquisition unit may also include an analog-to-digital converter to convert the acquired signals from the continuous time domain to a discrete time domain. The analog-to-digital converter may then provide the digitized data to the processor for further analysis or for communication to a remote processing device 108 or remote cloud server 110 for further analysis.

Optionally, the electronics module 104 may include a processor configured to perform the signal processing and analysis. In some cases, the processor may be coupled to the communication module (and thereby the sensing unit) using a wired connection such as Universal Serial Bus (USB) or other port.

The electronics module 104 can be communicatively coupled to one or more remote processing devices 108a-108n, e.g., using a wireless communication module (e.g., Bluetooth, Bluetooth Low-Energy, Wi-Fi, ANT+ IEEE 802.11, etc.). The remote processing devices 108 can be any type of processing device such as a personal computer, a tablet, and a mobile device such as a smartphone, a smartwatch or a wristband for example. The electronics modules 104 can also be communicatively coupled to a remote cloud server 110 over, for example, a wide area network such as the Internet.

Each remote processing device 108 and optional remote cloud server 110 typically includes a processing unit, an output device (such as a display, speaker, or tactile feedback device), a user interface, an interface unit for communicating with other devices, Input/Output (I/O) hardware, a wireless unit (e.g., a radio that communicates using CDMA, GSM, GPRS or Bluetooth protocol according to standards such as IEEE 802.11a, 802.11b, 802.11g, or 802.11n), a power unit and a memory unit. The memory unit can include RAM, ROM, one or more hard drives, one or more flash drives or some other suitable data storage elements such as disk drives, etc.

The processing unit controls the operation of the remote processing device 108 or the remote cloud server 110 and can be any suitable processor, controller or digital signal processor that can provide sufficient processing power depending on the desired configuration, purposes and requirements of the system 100.

The display can be any suitable display that provides visual information. For instance, the display can be a cathode ray tube, a flat-screen monitor and the like if the remote processing device 108 or remote cloud server 110 is a desktop computer. In other cases, the display can be a display suitable for a laptop, tablet or handheld device such as an LCD-based display and the like.

System 100 can generally be used to obtain force sensor data from a user.

System 100 can also be configured to analyze the force sensor data in order to determine force-related values or other derived data such as synthesized sensor readings for example. System 100 can also be configured to use force sensor data from one type of sensor (e.g., a normal force sensor) to adjust or correct sensor readings from a different type of sensor (e.g. a shear force sensor). For example, normal force sensor measurements can be used to correct the shear force sensor measurements by subtracting any normal force component measured by the shear sensor. The sensor readings, adjusted sensor readings, force-related values, and derived data may be monitored, stored, and analyzed for the user. Aspects of the monitoring, storage and analysis of sensor readings, force-related values, and derived data may be performed by one or more of the input unit 102, and/or a remote processing device 108, and/or the cloud server 110.

A remote cloud server 110 may provide additional processing resources not available on the input unit 102 or the remote processing device 108. For example, some aspects of processing the sensor readings acquired by the sensors 106 may be delegated to the cloud server 110 to conserve power resources on the input unit 102 or remote processing device 108. In some cases, the cloud server 100, input unit 102 and remote processing device 108 may communicate in real-time to provide timely feedback to a user regarding the sensor readings, force sensor values and data derived therefrom.

Referring now to FIG. 2A, shown therein is an example of an insole 200 that includes a sensing unit 202. The insole 200 is an example of an input device 102 that may be used in the system 100 shown in FIG. 1.

The insole 200 includes a sensor unit 202 and an optional liner 204. The liner 204 can provide a protective surface between the sensor unit 202 and an individual's foot. The liner 204 may have a slightly larger profile as compared to the sensor unit 202. That is, the outer perimeter 203 of the sensor unit 202 may be inwardly spaced from the outer perimeter 205 of the liner 204 by an offset 208. The offset 208 may be substantially consistent throughout the perimeter of the sensor unit 202 such that the sensor unit 202 is complete covered by the liner 204.

The sensor unit 202 can also include a connector 206. The connector 206 may provide a coupling interface between the plurality of sensors 106 and an electronics module (not shown) such as electronics module 104. The coupling interface can allow signals from the sensors 106 to be transmitted to the electronics module. In some cases, the coupling interface may also provide control or sampling signals from the electronics module to the sensors 106.

FIG. 2B illustrates the sensor unit 202 with the liner 204 omitted. Sensor unit 202 is an example of a sensor unit that may be used as sensing unit 105 in system 100 in which only normal force sensors are present. As illustrated, the plurality of sensors 106 are arranged in a predetermined pattern (also referred to as a sensor layout or predetermined sensor layout) where the sensors 106 are spaced apart from one another. The sensors 106 provide a set of discrete sensors that are distributed across the sensor unit 202.

The sensor unit 202 illustrated in FIGS. 2A and 2B includes force sensors usable to the normal force applied to an insole by a user (e.g., to measure the user's bodyweight). As used herein, normal force refers to the force acting between the sensing unit (e.g., an insole) and a surface in a direction perpendicular, or “normal” to the surface.

In some examples, it may be advantageous to provide a sensor set that includes force sensors capable of directly measuring additional force. For example, it may be desirable to measure vertical torque and/or shear force acting on the sensor unit. In the example of input unit 200, it may be desirable to measure additional forces in the plantar region of the user's foot.

As used herein, shear force refers to the force acting between the sensing unit (e.g., an insole) and a surface in a direction parallel to the surface. Where the sensing unit is provided using an insole or other footwear, the shear force may be referred to as a plantar shear force. In the description that follows, the term shear force may be used interchangeably with plantar shear and shear stress.

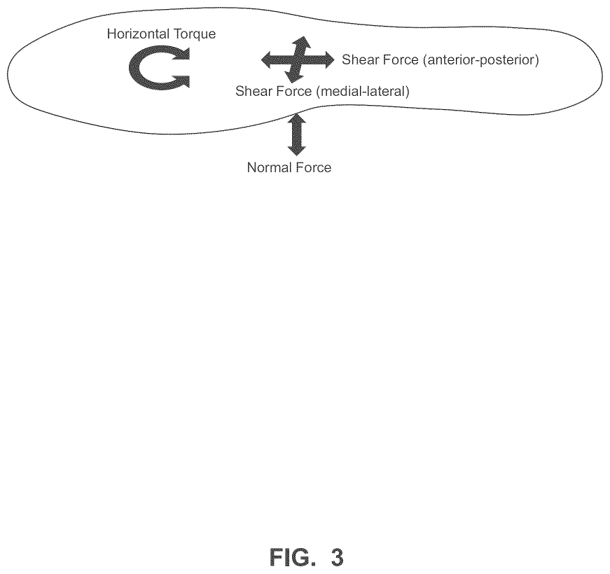

The shear force can be separated into different components based on the direction of the shear force that is applied. For example, the shear force may be divided into anterior-posterior and medial-lateral components that are defined based on the configuration of the sensing unit or input unit 102 with respect to a user's body. In the example of a sensing unit in the form of an insole or other footwear the shear force may be divided into anterior-posterior and medial-lateral components as shown in the example of FIG. 3.

As used herein, vertical torque refers to a twisting force acting between the sensing unit (e.g., an insole) and a surface in the transverse plane parallel to the surface. The vertical torque is a rotation about the vertical (longitudinal axis). Where the sensing unit is provided using an insole or other footwear, the vertical torque may be referred to as a plantar vertical torque.

Aspects of lower-limb injuries and athletic performance are related to the shear force and torque experienced in the foot or plantar region. Traditionally, shear force and torque at the plantar surface has been measured in a laboratory setting with the use of force plates and strain gauges. However, outside of this type of controlled environment, it can be difficult to measure shear force and vertical torque in the plantar region. For example, strain gauges used to measure shear force and vertical torque are often individually calibrated and are sensitive to environmental changes such as temperature. Accordingly, wearable devices used to measure the force underfoot often include sensors for measuring the normal force but not sensors for measuring the shear force or vertical torque.

The sensors, sensor systems, and methods described herein may enable shear force and/or vertical torque to be measured outside of controlled laboratory settings. In particular, the present disclosure relates to the use of force-sensing resistors (FSR) configured to measure shear force and/or vertical torque.

FSRs can be designed, manufactured, and tested with relatively inexpensive equipment. FSRs are also quite thin. As a result, sensor systems using FSRs can be easily integrated into wearable devices and other fitness equipment or accessories. The FSRs may be imperceptible to users when embedded in a carrier unit due to the very thin nature of the sensors. Accordingly, FSRs can be used to measure the shear force and vertical torque in the plantar region while providing little to no discomfort to the user. FSRs used to measure shear force and vertical torque can be manufactured at a similar cost to FSRs used for measuring normal force.

Because of the easy integration into wearable devices, FSRs can be used to track and measure athletic performance and likelihood of injury in the field, providing real-time data in situations where an injury is most likely to occur. For example, FSRs may be used to track athletes during high-impact sport activities, or may be used to monitor daily-living activities such as through diabetic monitoring. FSRs may also be used as inputs to a foot-mounted game controller or a game console.

FSRs configured to measure shear force and/or torque may also be integrated into the same sensor system as normal-force sensing FSRs, without the need for additional hardware or electronics (see e.g., FIGS. 13A-13C for example).

FSRs used to measure normal force can operate by having at least one layer of FSR material and at least one layer of conductive material. These layers can be positioned on opposing flexible substrates and may include an optional spacing layer therebetween. When a normal force is applied, the layers are pushed closer together and the FSR layers forms a bridge between the conductive layers. This bridge, acting as a wire, creates a drop in resistance and increases the current flow through the sensor. The resistance can then be converted into force values.

FSRs described herein may be provided in a wide variety of shapes, sizes, and/or patterns, thereby allowing for the measurement of additional forces, such as shear force and/or vertical torque. For example, instead of positioning the FSR and conductive layers directly above one another, as is done with normal force-sensing FSRs, the layers can be positioned adjacent to one another (e.g., in a laterally offset arrangement). Accordingly, during use, an applied shear force and/or vertical torque results in the adjacently positioned layers either sliding past one another, pushing the FSR layers closer together and decreasing the resistance in the circuit, or pulling the FSR layers farther apart, increasing the resistance in the circuit. The change in resistance can then be converted into force values.

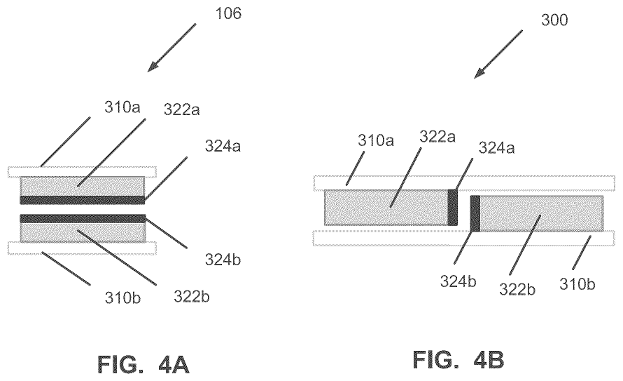

Referring now to FIG. 4A, shown therein is an example of a normal force sensor 106. As shown in the example of FIG. 4A, the normal force sensor 106 has an upper substrate layer 310a and a lower substrate layer 310b. Optionally, the substrate layers 310 are flexible substrate layers such as polyethylene terephthalate (PET) or polyester.

The upper substrate layer 310a has a lower surface 312a and the lower substrate layer 310b has an upper surface 312b. The upper surface 312b is in a facing relationship with the lower surface 312a of the upper substrate layer 310a.

An upper sensor portion 320a has an upper conductive layer 322a applied to the lower surface 312a of the upper substrate layer 310a. An upper force-sensitive resistor (FSR) layer 324a is applied to the upper conductive layer 322a. A lower sensor portion 320b has a lower conductive layer 322b applied to the upper surface 312b of the lower substrate layer 310b. A lower force-sensitive resistor layer 324b is applied to the lower conductive layer 322b.

The conductive layers may be any material capable of conducting an electrical current. For example, the conductive layers may be manufactured using a low-resistance material such as copper, silver (as mentioned above), gold, conductive ink, temperature resistive ink, or a combination of the above low-resistance materials. The conductive material chosen may vary depending on the desired sensor measurement range, as different conductive materials have different resistive properties.

The FSR layers may be any material capable of varying resistance as a result of applied force. The FSR layers may be manufactured from suitable resistive materials that have a higher resistance than the low-resistance material used in either of the conductive layers 322. The FSR layers may be manufactured using various materials, including, but not limited to graphene, piezoelectric materials, piezoresistive materials, force-sensing materials, force-sensing resistors, force-sensing resistor inks, and any combination of the above materials.

In the normal force sensor shown in FIG. 4A, the lower FSR layer 324b and the upper FSR layer 324a are vertically spaced apart from one another under a zero-force condition. The lower FSR layer 324b and the upper FSR layer 324a are also aligned in the lateral direction so that they can contact one another in response to a force that is applied solely in a vertical direction. This configuration can be used to measure the normal force that acts on the sensor 106. In other words, when a normal force is applied to the substrates, the upper FSR layer 324a may contact the lower FSR layer 324b, causing a reduction in resistance of the circuit. This reduced resistance can be converted into a measurement of the applied force.

Alternatively, the lower FSR layer 324b and the upper FSR layer 324a may be in contact under the zero-force condition. Under the initial contact condition, the resistance may be mapped to a normal force of zero. When normal force is applied, the resistance may decrease as the contact between the FSR layers increases.

Referring now to FIG. 4B, shown therein is an example sensor 300. The sensor 300 is generally similar to the normal force sensor 106 except that the lower FSR layer 324b and the upper FSR layer 324a are laterally offset from one another under a zero-shear force condition and/or a zero-torque condition. A zero-shear force condition refers to a condition in which no shear force is acting on the sensor 300. A zero-torque condition refers to a condition in which no torque is acting on the sensor 300.

As shown in the example of FIG. 4B, the lower FSR layer 324b and the upper FSR layer 324a are not aligned in a vertical plane. That is, the FSR layer 324b and the upper FSR layer 324a would not contact one another in response to a normal force being applied to the substrate layers 310.

However, the lower FSR layer 324b and the upper FSR layer 324a are moveable laterally towards or away from each other in response to a shear force and/or a torque. Since the FSR layers are laterally offset from one another, an applied shear force and/or torque that pushes the FSR layers together can decrease the resistance of the circuit, while an applied shear force and/or torque that pulls the FSR layers away from each other can increase the resistance of the circuit. In each instance, pulling or pushing, the change in resistance can be used to determine the applied shear force and/or torque.

As exemplified in FIG. 4B, the lower FSR layer 324b and the upper FSR layer 324a may be spaced apart under the zero-shear force condition and/or the zero-torque condition. In this spaced apart condition, when shear force and/or torque is applied, the resistance may decrease as the FSR layers come into contact with one another and as the contact increases.

Alternatively, the lower FSR layer 324b and the upper FSR layer 324a may be in contact under the zero-shear force condition and/or the zero-torque condition. Under the initial contact condition, the resistance may be mapped to a shear force and/or torque of zero. When shear force and/or torque is applied, the resistance may decrease as the contact between the FSR layers increases.

The conductive layers may be any shape and/or size, provided the force sensor 300 can still be contained within or on the desired carrier unit. Optionally, the conductive layers 322 may be thicker than the FSR layers 324 as shown in the example of FIG. 4B. Manufacturing the conductive layers 322 to be thicker than the FSR layers 324 may allow for increased control over the spacing between the two conductive layers without the addition of more conductive materials. Additional conductive material may change the overall resistive properties of the sensor, which may impact properties of the sensor, such as time to signal onset. Controlling the spacing between the two conductive layers may allow for improved control over the action of the sensor properties.

The cross-sectional profile of the upper sensor portion 320a and the lower sensor portion 320b can vary between sensors 300. Various examples of cross-sectional profiles that may be used are shown in FIGS. 5A-5D.

Optionally, the upper sensor portion 320a and the lower sensor portion 320b may have different cross-sectional profiles. The use of differing cross-sectional profiles between the upper sensor portion 320a and the lower sensor portion 320b may allow for increased sensitivity of the sensor 300. For example, the upper sensor portion 320a may have a rectangular cross-sectional profile and the lower sensor portion 320b may have a triangular cross-sectional profile. The smaller cross-sectional profile of the lower sensor portion 320b may allow it to be more sensitive to small movements between the sensor layers, thereby allowing for the accounting of small signals due to limited movement of the user.

Alternatively, the upper sensor portion 320a and the lower sensor portion 320b can have the same cross-sectional profile.

Optionally, each of the upper sensor portion 320a and the lower sensor portion 320b may have a symmetrical profile (cross-section). For example, the sensors 300 shown in FIGS. 5A-5C respectively are examples of force sensors in which the upper sensor portion 320a and the lower sensor portion 320b have a symmetric profile.

Optionally, the width of the upper sensor portion 320a and/or the lower sensor portion 320b may remain consistent throughout the respective sensor portion. For instance, the sensor 300 shown in FIG. 5A is an example of a force sensor in which the upper sensor portion 320a and the lower sensor portion 320b both have rectangular profiles (i.e. a consistent width).

Alternatively, the profile of one or both of the upper sensor portion 320a and the lower sensor portion 320b can be non-rectangular. In other words, the width of the upper sensor portion 320a and/or the lower sensor portion 320b can change through the respective sensor portion. For example, as shown in FIGS. 5B-5D, sensors 300 are provided with a tapered profile. The example tapered profiles shown in FIGS. 5B-5D are examples of sensor portions in which the width of the sensor portion decreases from an outer side (i.e. the side of the sensor portion away from the other sensor portion) towards an inner side (i.e. the side of the sensor portion positioned to interact with the opposing sensor portion).

The sensor 300 shown in FIG. 5B has a trapezoidal profile while the sensors 300 shown in FIGS. 5C and 5D have triangular profiles. Tapering the profile of the upper sensor portion 320a and/or the lower sensor portion 320b may provide a larger surface area for interaction between the sensor portions, thereby allowing for larger drops in resistance upon contact and therefore a larger measurement range.

Depending on the arrangement of the upper sensor portion 320a and the lower sensor portion 320b, a normal force may in fact cause the FSR layers 324 to move relative to one another (particularly where a tapered profile is used). Accordingly, the sensor measurements from the force sensors 300 may be adjusted using normal force values obtained from normal force sensors that are part of the same sensor system. That is, the normal force detected by a normal force sensor can be used to adjust the sensor readings from the force sensor 300 to remove the impact of an applied normal force.

Optionally, the upper sensor portion 320a and the lower sensor portion 320b may have an asymmetric profile. For example, the triangular profile of the sensor 300 shown in FIG. 5D is an asymmetric profile. As shown in the example of FIG. 5D, the profile of the sensor portions may be a right angle. A right-angle profile may provide the greatest surface area for interaction and therefore the largest measurement range.

In addition to varying cross-sectional profiles, the force sensors can also be configured with an interdigitated arrangement of the upper sensor portion 320a and the lower sensor portion 320b. That is, the upper sensor portion 320a and the lower sensor portion 320b can be arranged so that they interdigitate in response to an applied shear force and/or torque.

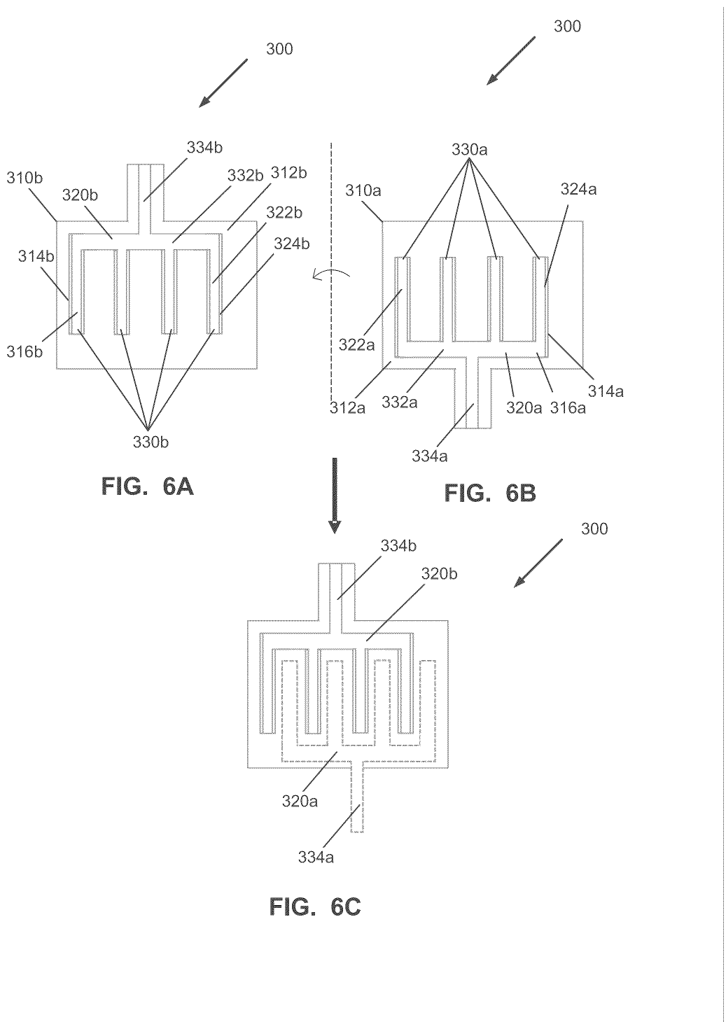

FIGS. 6A to 6C illustrate an example sensor 300 with an interdigitated arrangement of sensor layers. As shown in FIG. 6B, the upper FSR layer 324a has a plurality of upper force-sensitive strips 330a (upper strips) that are applied to the upper conductive layer 322a. As shown in FIG. 6A, the lower FSR layer 324b has a plurality of lower force-sensitive strips 330b (lower strips) that are applied to the lower conductive layer 322b. In other words, as shown, the FSR layers can be patterned such that when a shear force and/or torque is applied, the FSR layers can become interdigitated (i.e., the various strips can interlock or engage with one another).

The conductive layers 322 can also be applied as conductive strips to the respective substrates as shown (e.g. an upper conductive strip 322a and a lower conductive strip 322b). The force-sensitive strips 330 can then be applied to the corresponding conductive strips 322. Optionally, strips of force-sensitive layers 330 may be applied to the lateral edges of the strips of conductive layers 322. Alternatively or in addition, the force-sensitive layers 300 can be applied to other portions of the respective conductive layers 322, such as the lower portion of the upper conductive layer 322a and the upper portion of the lower conductive layer 322b.

As shown in FIG. 6C, the upper FSR layer 324a and the lower FSR layer 324b are laterally offset. The upper FSR layer 324a and the lower FSR layer 324b are moveable in a lateral direction in response to a shear force and/or torque. When the upper sensor portion 320a and the lower sensor portion 320b are placed together, the strips 330a and 330b are interdigitated. Use of an interdigitated pattern may increase the surface area of interaction between the upper sensor portion 320a and the lower sensor portion 320b, thereby increasing the measurement range of the sensors.

Optionally, the plurality of upper strips 330a may be parallel and the plurality of lower strips 330b may be parallel as shown in the example of FIGS. 6A-6C. Alternatively, the strips 330 may not be parallel.

As shown in FIG. 6B the upper strips 330a can be connected to one another along an upper joining portion 332a. Similarly, the lower strips 330b can be connected to one another along a lower joining portion 332b as shown in FIG. 6A. The upper joining portion 332a may have an upper tail 334a, and the lower joining portion 332b may have a lower tail 334b. The tails can provide connectivity between the sensor 300 and the rest of the sensing circuit (e.g., connectors to the electronics module).

The profile of the upper sensor portion 320a and the lower sensor portion 320b may be tapered, as described above, to allow the upper strips 330a and the lower strips 330b to interact over a larger surface area when a shear force and/or torque is applied.

In the example shown in FIGS. 6A-6C, each of the upper sensor portion 320a and the lower sensor portion 320b have four strips. It will be appreciated that there may be any number of strips, provided that the upper and lower portions can be interdigitated upon application of a shear force and/or torque. The strips and/or interdigitations may be any size and/or thickness provided interdigitation can occur such that shear force and/or torque can be measured. The pattern of the upper sensor portion 320a and the lower sensor portion 320b may be interchangeable. In other words, provided the FSR layers can interdigitate, either pattern can be provided on either surface.

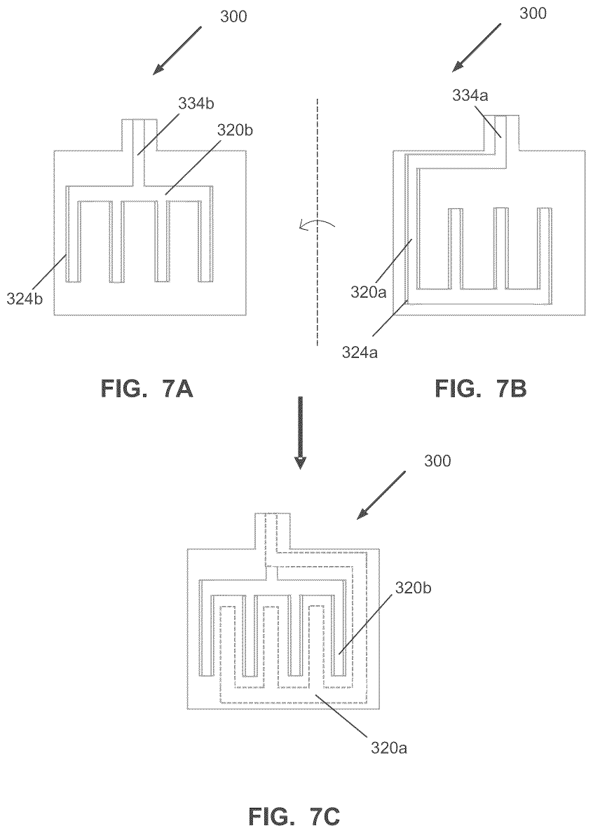

The position of the upper tail 334a and lower tail 334b may vary depending on the structure of the force sensor 300. For example, as shown in FIGS. 6A-6C, the tails 334a and 334b are on opposing sides such that when the upper sensor portion 320a and the lower sensor portion 320b are placed into contact, the tails 334a and 334b do not touch. Alternatively, as shown in the example of FIGS. 7A-7C, the upper tail 334a and the lower tail 334b can be positioned on the same side. The sensor shown in FIGS. 7A-7C is generally the same as the sensor shown in FIGS. 6A-6C except for the arrangement of the upper tails 334a.

Optionally, the plurality of upper strips 330a and the plurality of lower strips 330b may be evenly spaced from one another under the zero-shear condition. In this configuration, the shear measurement is non-directional, as movement of the upper sensor portion 320a and the lower sensor portion 320b in either direction away from the zero-shear position will result in a drop in resistance.

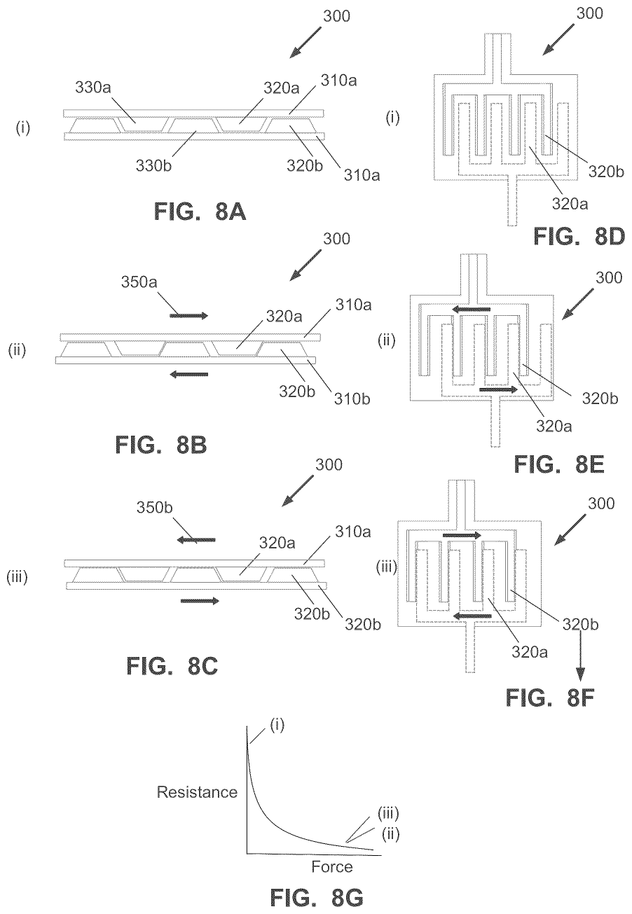

FIGS. 8A-8F show examples of various shear loading conditions of a sensor 300 in which the upper strips 330a and the lower strips 330b are evenly spaced from one another under a zero-shear condition. As shown in FIGS. 8A-8C, the upper sensor portion 320a and the lower sensor portion 320b both have a symmetric cross-sectional profile. Accordingly, both edges of the upper strips 330a and the lower strips 330b will interact with other strips depending on the shear loading condition.

FIGS. 8A and 8D illustrate a cross-section and top view of the sensor 300 in a zero-shear condition (i). FIGS. 8B and 8E illustrate a cross-section and top view of the sensor 300 with a shear force (ii) being applied in a first direction 350a that pushes the upper strips 330a and the lower strips 330b into contact with one another. FIGS. 8C and 8F illustrate a cross-section and top view of the sensor 300 with a shear force (iii) being applied in a second direction 350b that pushes the upper strips 330a and the lower strips 330b into contact with one another. The first direction and the second direction of the shear force are perpendicular to the upper strips 330a and the lower strips 330b. As shown by FIGS. 8E and 8F, the upper strips 330a and the lower strips 330b come into contact with one another in response to forces 350 in opposite directions.

FIG. 8G illustrates a plot of resistance vs force for the FSR sensor 300 shown in FIGS. 8A-8F. The plot shown in FIG. 8G indicates where each of the loading conditions (i), (ii), and (iii) fall on the curve. The sensor shown in FIGS. 8A-8F is a non-directional shear force sensor, since movement in either direction away from the zero-shear force position will result in a drop in resistance.

Alternatively, the interdigitated strips can be arranged with a non-uniform spacing under zero-shear and zero-torque conditions. In other words, the upper strips 330a and the lower strips 330b may be unevenly spaced from one another under the zero-shear condition. This non-uniform spacing may be provided in various ways. For example, symmetrical strip profiles may be positioned at non-uniform distances, strips with asymmetrical profiles may be positioned at uniform distances, or strips with asymmetrical profiles may be positioned at non-uniform distances. Force sensors with non-uniformly spaced strips under zero-shear conditions may allow directional shear forces to be measured.

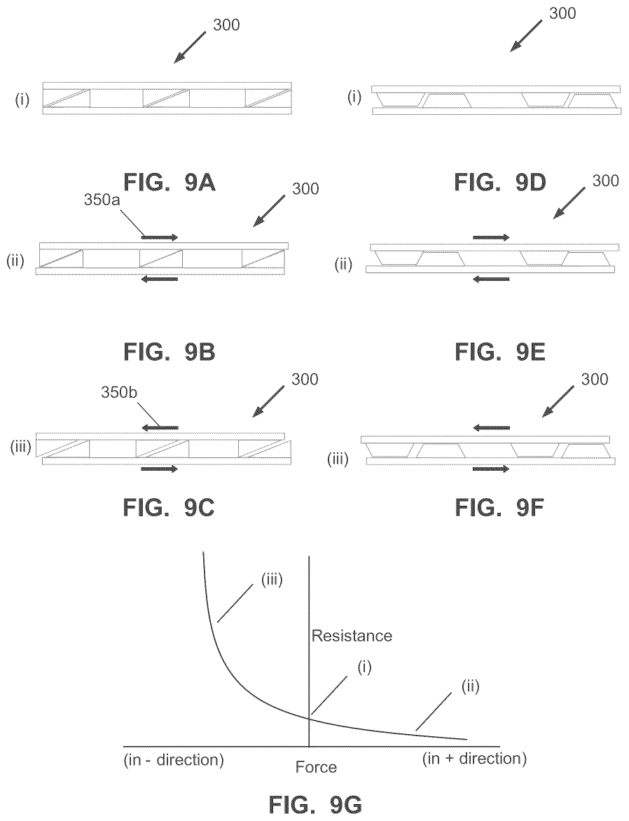

Referring to FIGS. 9A-9F, shown therein is an example of a force sensor 300 in which interdigitated strips are provided in an asymmetric arrangement with triangular (FIGS. 9A-9C) and trapezoidal (FIGS. 9D-9F) profiles. As shown, FIGS. 9A and 9D illustrate the zero-shear condition (i) for each profile type. FIGS. 9B and 9E illustrate the position (ii) of the sensor portions 320 in response to a shear force being applied in a first direction 350a that pushes the upper strips 330a and the lower strips 330b into contact with one another. FIGS. 9C and 9F illustrate the position (iii) of the sensor portions 320 in response to a shear force being applied in a second direction 350b. In contrast to the symmetric sensor example shown in FIGS. 8C and 8F, the upper strips 330a and the lower strips 330b are moved away from one another in response to the shear force being applied in the second direction 350b.

FIG. 9G illustrates a plot of resistance vs force for the FSR sensor 300 shown in FIGS. 9A-9F. The plot shown in FIG. 9G indicates where each of the loading conditions (i), (ii), and (iii) fall on the curve. As shown in FIG. 9G, the loading conditions (ii) and (iii) result in different resistance values for an applied force. Accordingly, the sensors shown in FIGS. 9A-9F allow for a directional shear force to be determined.

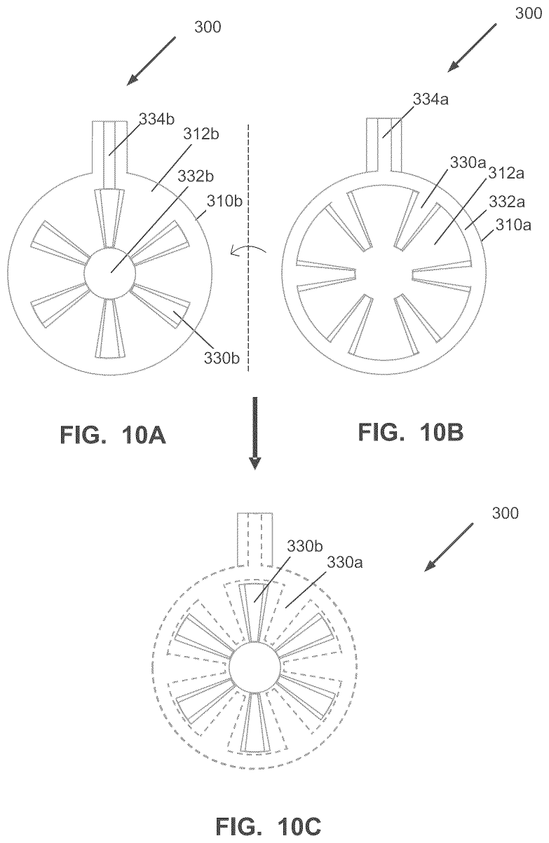

Referring to FIGS. 10A-10C, shown therein is an example of a force sensor 300 in which the sensor portions 320 are arranged using a pinwheel pattern. As shown in FIGS. 10A and 10B, the plurality of upper strips 330a are arranged in an upper pinwheel pattern and the plurality of lower strips 330b may be arranged in a lower pinwheel pattern.

The example interdigitated pinwheel pattern shown in FIGS. 10A-10C can be used to measure a vertical torque. In response to a torque acting on the sensing unit, the sensor portions 320 shown in FIG. 10A-10C can twist towards or away from one another according to the pinwheel pattern. In the example illustrated, the upper and lower sensor portions 320 are evenly spaced from one another such that the vertical torque measurement is non-directional.

As shown in FIG. 10A, the lower strips 330b are connected by a central joining portion 332b. As shown in FIG. 10B, the upper strips 330a are offset from the lower strips 330b. The upper strips 330a are connected by an outer joining portion 332a. When the two layers are assembled, as shown in FIG. 10C, the strips 330a and 330b are interdigitated. While six upper strips 330a and six lower strips 330b are shown, it will be appreciated that the number of strips may vary.

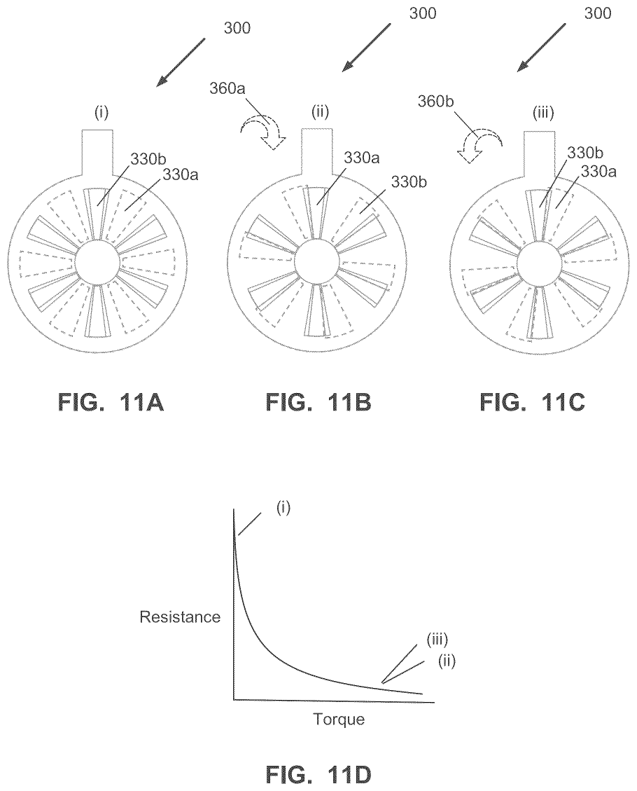

Referring to FIGS. 11A-11C, shown therein is an example of a force sensor 300 in which interdigitated pinwheel pattern is provided in a symmetric arrangement. The arrangement of the sensor portions shown in FIGS. 11A-11C are defined such that when vertical torque is applied, the pinwheel pattern can rotate and move the upper strips 330a and the lower strips 330b into contact with one another, thereby creating a drop in resistance.

As shown, FIG. 11A illustrates the zero-shear condition (i). FIG. 11B illustrates the position (ii) of the sensor portions 320 in response to a torque being applied in a first (clockwise) direction 360a that pushes the upper strips 330a and the lower strips 330b into contact with one another. FIG. 11C illustrates the position (iii) of the sensor portions 320 in response to a torque being applied in a second (counter-clockwise) direction 360b that pushes the upper strips 330a and the lower strips 330b into contact with one another, but in the opposite direction.

The strips 330a and 330b shown in FIGS. 11A-11C have a symmetrical tapered profile, allowing both edges of the strips to interact with other strips. FIG. 11D illustrates a plot of resistance vs force for the FSR sensor 300 shown in FIGS. 11A-11C. The plot shown in FIG. 11D indicates where each of the loading conditions (i), (ii), and (iii) fall on the curve. The sensor shown in FIGS. 11A-11C is a non-directional torque sensor, since rotation in either direction away from the zero-torque position will result in a drop in resistance.

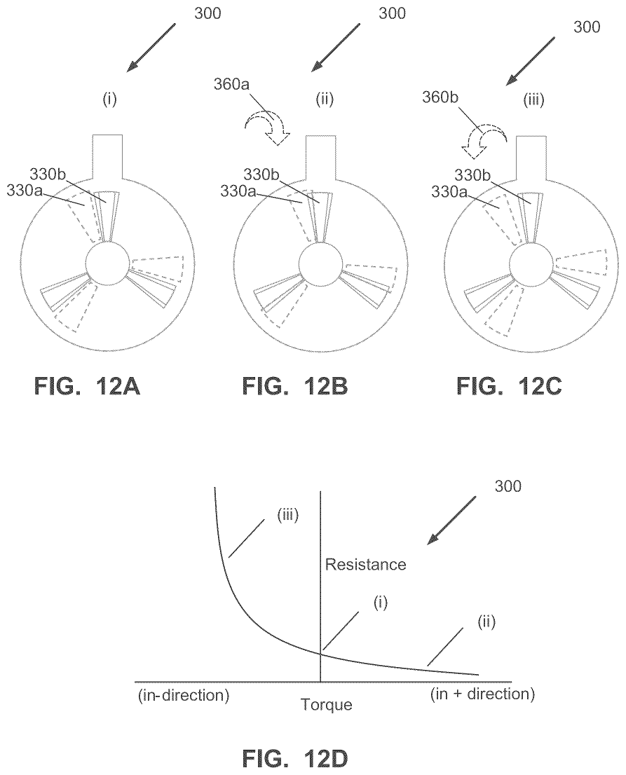

Referring to FIGS. 12A-12C, shown therein is an example of a force sensor 300 in which an interdigitated pinwheel pattern is provided with an asymmetric configuration. That is, the upper and lower strips 330 are not uniformly spaced under zero-torque conditions. This configuration allows for directional torque measurement in a similar manner as described above with regard to directional shear force measurement (i.e., in FIGS. 9A-9G).

As shown, FIG. 12A illustrates the zero-shear condition (i). FIG. 12B illustrates the position (ii) of the sensor portions 320 in response to a torque being applied in a first (clockwise) direction 360a that pushes the upper strips 330a and the lower strips 330b into contact with one another, thereby creating a drop in resistance. FIG. 12C illustrates the position (iii) of the sensor portions 320 in response to a torque being applied in a second (counter-clockwise) direction 360b that pushes the upper strips 330a and the lower strips 330b away from one another, thereby increasing the resistance.

FIG. 12D illustrates a plot of resistance vs force for the FSR sensor 300 shown in FIGS. 12A-12C. The plot shown in FIG. 12D indicates where each of the loading conditions (i), (ii), and (iii) fall on the curve. As shown in FIG. 12D, the loading conditions (ii) and (iii) result in different resistance values for an applied torque. Accordingly, the sensors shown in FIGS. 12A-12C allow for a directional torque to be determined.

Optionally, the force sensors 300 may include force sensing resistive material on a limited portion of the conductive layers 322. This may help reduce the cost of manufacturing a force sensor, by reducing the volume of force sensing resistive material required. Alternatively, the force sensing resistive material may be provided to cover the conductive layers 322. This may simplify manufacturing by ensuring a greater surface area of the upper and lower sensor portions can detect applied forces.

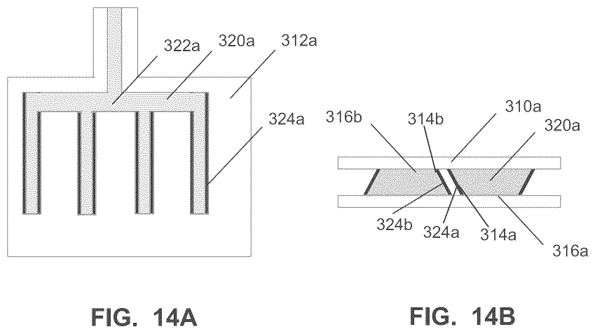

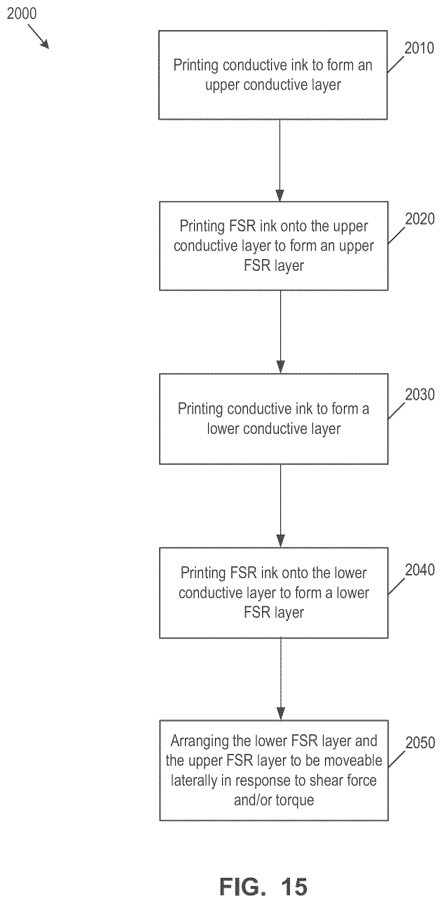

Referring now to FIGS. 14A and 14B, shown therein is an example of a force sensor 300 in which the force sensing layers 324 are only provided on a portion of the conductive layers 322. The conductive layers 322 may have surface portions that will interact with one another in response to applied shear forces and/or torques (referred to as interacting surface portions). There may also be other portions (non-interacting surface portions) of the conductive layers 322 that will not interact (or that do not need to interact in order to sense the applied force). The force sensing layers 32 may be omitted from such non-interactive surface portions.

For example, the upper conductive layer 322a may include one or more interacting lateral surface portions 314a and one or more non-interacting lower surface portions 316a. The lower conductive layer 322b can also include one or more interacting lateral surface portions 314b and one or more non-interacting upper surface portions 316b. Each interacting lateral surface portion 314a can be positioned to contact the corresponding interacting lateral surface portion 314b under certain applied force conditions, such as shear force and/or torque.

As shown in the example of FIGS. 14A and 14B, the upper FSR layer 324a is only applied to the interacting lateral surface portions 314a of the upper conductive layer 322a. The upper FSR layer 324a is omitted from the non-interacting lower surface portions 316a of the upper conductive layer 322a.

Similarly, the lower FSR layer 324b is only applied to the interacting lateral surface portions 314b of the lower conductive layer 322b. The lower FSR layer 324b is omitted from the non-interacting upper surface portions 316b of the lower conductive layer 322b.

Optionally, the force sensors 300 can be used in a sensor system. The sensor system can include a plurality of force sensors including force sensors of different types. This may allow different forces acting on the sensor system to be measured directly to provide a better overall understanding of the different forces acting on the sensor system.

Referring now to FIGS. 13A-13C, shown therein is an example of a sensor system 1000. The sensor system 1000 includes a plurality of force sensors. The plurality of force sensors may be arranged in a pre-determined pattern for measuring one or more forces applied by a user.

The plurality of sensors can include one or more normal force sensors 106. The plurality of sensors can also include at least one additional sensor of a different sensor type. For example, the at least one additional sensor can include one or more medial-lateral shear sensors 300a and/or one or more anterior-posterior shear sensors 300b and/or one or more torque sensors 300c.

As shown in FIG. 13A, the system 1000 can include a plurality of normal force sensors 106, a plurality of medial-lateral shear sensing FSR 300a, a plurality of anterior-posterior shear-sensing FSR 300b, and a plurality of vertical torque-sensing FSR 300c. The plurality of force sensors can be arranged throughout the system 1000 to measure different forces acting on the sensor system 1000 at different locations of the sensor system. For example, as shown in FIG. 13A, the plurality of sensors are arranged to have at least one of each sensor type positioned in the forefoot and the rearfoot, thereby allowing for measurement of a plurality of forces and/or torques in each region. The arrangement of the various sensors in the plurality of regions may vary depending on the desired use of the system 1000.

Optionally, the plurality of force sensors may be provided using a plurality of force sensor layers 400. Each force sensor layer 400 may include the same type of sensor. That is, each force sensor layer 400 may have a different type of sensor. This may allow different types of sensors to be provided across the sensor system, including in overlapping configurations. Optionally, at least one force sensor layer 400 may include a plurality of different types of force sensors.

As shown in the example of FIG. 13B, each of the different types of sensors 300a, 300b, 300c, and 300d can be provided on distinct force sensor layers 400a, 400b, 400c, and 400d respectively. A plurality of force sensor layers 400 may allow for larger sensors to be manufactured. For example, shear and torque sensors may be made relatively large, since the flexible substrates on which these sensors are positioned may deform relatively less under shear force and torque as compared to under normal force. In other words, the deformation of the substrate on which the shear and torque sensors are positioned may undergo relatively minute deformation. Accordingly, use of larger sensors may help to detect the minute deformations. Additionally, the use of a plurality of force sensor layers 400 may allow at least some of the force sensors from different force sensor layers 400 to at least partially overlap one another. The overlap of sensors may allow for larger sensors to be manufactured, as described above. FIG. 13C illustrates a collapsed view of the sensor system 1000 of FIG. 13B with the various force sensor layers compressed or laminated into a substantially planar sensor unit.

The system 1000 can also include one or more processors (not shown) that are communicatively coupled to the plurality of force sensors 106/300. The one or more processors may be configured to transmit signals external to the sensor system 1000 based on an output of the plurality of force sensors.

The one or more processors can also be configured to adjust the sensor readings from one type of sensor (e.g., a shear sensor 300a or 300b or torque sensor 300c) based on the sensor readings from another type of sensor (e.g. normal force sensor 106). For example, the one or more processors can be configured to determine a normal force component based on the sensor readings from the normal force sensors 106. The processors may then adjust the sensor readings from the shear force or torque sensors 300 by subtracting the normal force component.

Optionally, an initial normal force calibration may be performed for the shear force and torque sensors 300. Sensor readings can be obtained from the shear force and torque sensors 300 while a user is in a static position (e.g., a standing position) on flat ground. Any non-zero values from the shear force and/or torque sensors 300 can be identified as normal force components of the respective sensor readings. These non-zero values can be subtracted from any subsequent measurements made by the respective shear force and/or torque sensors 300.

Optionally, the system 1000 may include a carrier unit including the plurality of force sensors and the one or more processors. The carrier unit may be any device capable of receiving one or more forces applied by the user. For example, the carrier unit may be a wearable device, fitness equipment, fitness accessory, or any other article that may have force applied by a user while in use.

Optionally, the system 1000 can further include an inertial measurement unit (IMU). The IMU can include one or more sensors for measuring the position and/or motion of the sensor system 1000. For example, the IMU may include sensors such as one or more of a gyroscope, accelerometer (e.g., a three-axis accelerometer), magnetometer, orientation sensor (for measuring orientation and/or changes in orientation), angular velocity sensor, and inclination sensor.

The one or more processors can be configured to calculate shear force and/or torque using IMU measurements from the IMU in combination with sensor readings from the sensors 300. For example, Kalman filtering or a sensor fusion algorithm can be used to combine the IMU measurements with the sensor readings. This may help improve the reliability of the shear sensor response under dynamic conditions such as changes in direction.

As shown in the example of FIGS. 13A-13B, the carrier unit may be an insole, such as an insert system 500 for footwear. The insert system 500 may include a first layer and a base layer with the plurality of force sensors and the one or more processors disposed between the first layer and the base layer. For example, the system 1000 may be positioned between two layers of foam.

The force sensors 300 and sensor system 1000 may be manufactured in various ways. Optionally, additive manufacturing can be used to manufacture the force sensors 300. Additive manufacturing may provide versatility in manufacturing the FSRs to allow for additional force measurements and to provide a force sensor with a desired arrangement of conductive layers 322 and force sensing resistive layers 324.

For example, to manufacture the upper sensor portion 320a, ink may be printed onto the upper substrate layer 310a (e.g., by screen printing). Additively, ink may be applied layer-by-layer, to build the ink up in a desired shape (e.g., to provide a desired cross-sectional profile).

Optionally, a template may be used to ensure that the ink is only applied in the desired locations. The template may be changed between layers of ink deposition to ensure that the desired profile is achieved. Once the conductive layer 322a has been printed in the desired pattern, an FSR layer can be applied. For example, FSR ink, such as graphene, can be printed onto the conductive layer 322a at desired locations.

Optionally, the FSR layer may be applied only on portions of the conductive layer 322 that is expected to interact with the opposing sensor portion in response to an applied force. For example, as shown in FIGS. 14A-14B, the upper conductive layer 322a is additively printed first and the upper FSR layer 324a can then printed onto only the interacting portion 314a of the upper conductive layer 322a.

A similar process can be performed for the lower sensor portion 320b. It will be appreciated that the printing of the upper and lower sensor portions may occur simultaneously or sequentially in any order. Once both portions are complete, they can be assembled and affixed together around the edges of the substrate layers, by, for example, glue or other fasteners. Affixing the edges of the upper and lower sensor portions may allow for increased deformation to occur under loading, thereby increasing the measurement range of shear force and torque detection.

Additive manufacturing may allow for conductive layers 322 of any shape and/or size to be manufactured, provided the force sensor 300 can still be contained within or on the desired medium such as an insert for footwear. As shown in the example of FIG. 4A-4B, the conductive layers 322 may be thicker than the FSR layers 324. This variation in thickness may make it easier for the FSR layer to be manufactured when using additive manufacturing. In other words, the conductive layers 322 may be thick enough to support the application of the FSR layers.

Referring now to FIG. 17, shown therein is a flow chart of an example method 2000 of manufacturing a force sensor. The method 2000 is an example of an additive manufacturing process that can be used to manufacture a force sensor capable of measuring a shear force or torque.

At 2010, conductive ink is printed onto a lower surface of an upper substrate to form an upper conductive layer.

At 2020, FSR ink is printed onto the lower surface of the upper conductive layer to form an upper FSR layer.

At 2030, conductive ink is printed onto an upper surface of a lower substrate to form a lower conductive layer.

At 2040, FSR ink is printed onto the upper surface of the lower conductive layer to form a lower FSR layer.

It will be appreciated that steps 2010-2020 and steps 2030-2040 can be performed in any order and may be performed concurrently.

At 2050, the lower FSR layer and the upper FSR layer are arranged to be in a laterally offset position under a zero-shear force condition and/or a zero-torque condition. The lower FSR layer and the upper FSR layer are also arranged to be moveable laterally towards or away from each other in response to a shear force and/or a torque.

Optionally, a calibration rig may be used to calibrate the sensors described herein. For example, the calibration rig may include an inclined plane, with a mass on the plane, and the sensor(s) may be positioned between the mass and the plane. The slope of the plane may be increased and/or decreased, thereby changing the amount of shear force applied to the sensors from the mass. Calibration coefficients can be determined for the shear force sensors through use of the calibration rig. The calibration coefficients can be stored in a non-transitory storage memory accessible to the processors of sensor system 1000. The calibration coefficients can be used to adjust the sensor readings obtained from the respective shear sensors.

Optionally, adjacent shear force and/or torque sensors may be used to correct or “zero” each other out when it is known that there is no shear force and/or torque being applied to the sensors. For example, if a sensor reads a different value than an adjacent sensor during the swing phase of walking and/or running (when no force is applied), the one or more processors can calculate sensor drift by determining the difference between the sensor reading and the reading of an adjacent sensor. The drift can then be subtracted from the first sensor to zero the measurements.

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A force sensor comprising:
an upper substrate layer having a lower surface;
an upper sensor portion comprising:
an upper conductive layer applied to the lower surface of the upper substrate layer; and
an upper force-sensitive resistor layer applied to the upper conductive layer;
a lower substrate layer having an upper surface in a facing relationship with the lower surface of the upper substrate layer;
a lower sensor portion comprising:
a lower conductive layer applied to the upper surface of the lower substrate layer; and
a lower force-sensitive resistor layer applied to the lower conductive layer;
wherein the lower force-sensitive resistor layer and the upper force-sensitive resistor layer are laterally offset under a zero-shear force condition and/or a zero-torque condition; and
the lower force-sensitive resistor layer and the upper force-sensitive resistor layer are moveable laterally towards or away from each other in response to a shear force and/or a torque.

1. The force sensor of claim 1, wherein the lower force-sensitive resistor layer and the upper force-sensitive resistor layer are in contact under the zero-shear force condition and/or the zero-torque condition.

2. The force sensor of claim 1, wherein the lower force-sensitive resistor layer and the upper force-sensitive resistor layer are spaced apart under the zero-shear force condition and/or the zero-torque condition.

3. The force sensor of claim 1, wherein each of the upper sensor portion and the lower sensor portion has a symmetrical profile.

4. The force sensor of claim 1, wherein each of the upper sensor portion and the lower sensor portion has a rectangular profile.

5. The force sensor of claim 1, wherein each of the upper sensor portion and the lower sensor portion has a non-rectangular profile.

6. The force sensor of claim 6, wherein the non-rectangular profile is a triangular profile.

7. The force sensor of claim 6, wherein the non-rectangular profile is a trapezoidal profile.

8. The force sensor of claim 1, wherein:
the upper force-sensitive resistor layer comprises a plurality of upper force-sensitive strips applied to the upper conductive layer; and
the lower force-sensitive resistor layer comprises a plurality of lower force-sensitive strips applied to the lower conductive layer.

9. The force sensor of claim 9, wherein the plurality of upper force-sensitive strips are parallel and the plurality of lower force-sensitive strips are parallel.

10. The force sensor of claim 9, wherein the plurality of upper force-sensitive strips are arranged in an upper pinwheel pattern and the plurality of lower force-sensitive strips are arranged in a lower pinwheel pattern.

11. The force sensor of claim 9, wherein the plurality of upper force-sensitive strips and the plurality of lower force-sensitive strips are evenly spaced from one another under the zero-shear condition.

12. The force sensor of claim 9, wherein the plurality of upper force-sensitive strips and the plurality of lower force-sensitive strips are unevenly spaced from one another under the zero-shear condition.

13. The force sensor of claim 13, wherein each of the upper sensor portion and the lower sensor portion has a right-angle triangle profile.

14. The force sensor of claim 1, wherein the upper force-sensitive resistor layer is applied to one or more upper lateral sides of the upper conductive layer and the lower force-sensitive resistor layer is applied to one or more lower lateral sides of the lower conductive layer.

15. The force sensor of claim 1, wherein the force sensor is manufactured using additive manufacturing.

16. The force sensor of claim 1, wherein each conductive layer comprises conductive ink.

17. The force sensor of claim 1, wherein each force-sensitive resistor layer comprises FSR ink.

18. The force sensor of claim 1, wherein
the upper conductive layer comprises one or more interacting lateral surface portions and one or more non-interacting lower surface portions;
the lower conductive layer comprises one or more interacting lateral surface portions and one or more non-interacting upper surface portions;
each interacting lower surface portion is positioned to contact a corresponding interacting upper surface portion under certain applied force conditions;
the upper force-sensitive resistor layer is omitted from the non-interacting lower surface portions; and
the lower force-sensitive resistor layer is omitted from the non-interacting upper surface portions.

19. The force sensor of claim 9, wherein the plurality of upper force-sensitive strips and the plurality of lower force-sensitive strips are perpendicular to a direction of the shear force.
